(19) United States
(12) Patent Application Publication
(10) Pub. No.: US 2026/0054268 A1
(43) Pub. Date: Feb. 26, 2026

(54) SHREDDER

(71) Applicant: Portafill International Limited, Dungannon (GB)

(72) Inventor: Malachy James RAFFERTY, Omagh (GB)

(73) Assignee: Portafill International Limited, Dungannon (GB)

(21) Appl. No.: 19/220,214

(22) Filed: May 28, 2025

(30) Foreign Application Priority Data
Jul. 24, 2024 (GB) 2410785.6

(51) Int. Cl. B02C 18/14; B02C 18/16; B02C 18/20

(52) U.S. Cl. CPC B02C 18/142; B02C 18/20; B02C 2018/162

(57) ABSTRACT

A shredder for shredding material, the shredder comprising a housing supporting two rotating shafts arranged parallel to each other, each shaft having a plurality of overlapping and offset transverse shredding blades along the shafts able to rotate on the shafts in a complementary fashion to shred the material thereinbetween, the shredding blade on each shaft nearest to the housing being an outermost shredding blade and having a gap between of the outermost shredding blade and the housing, wherein the gap at least partly comprises a V-shape.

### CROSS REFERENCE TO RELATED APPLICATIONS

This application claims priority benefit from Great Britain Application No. 2410785.6 filed on Jul. 24, 2024, entitled “Shredder”, which is incorporated herein by reference in its entirety.

### TECHNICAL FIELD

The present application generally relates to a shredder for reducing the size of various materials, and more particularly to a shredder designed for use in reducing industrial, construction, green and household waste, etc.

### BACKGROUND OF THE INVENTION

Industrial shredders are known in the art, generally having two parallel shafts with overlapping cutting blades thereon within a housing, designed to rotate in contrary motion so as to produce a shear force thereinbetween, which force can shred or reduce or crush etc. the material fed into the shedder.

Conventionally, all the cutting blades are the same, generally being a series of transverse cutting edges around the circumference of a thick circular body extending out from the shaft. As the blades alternate along the shaft to produce a complementary and overlapping arrangement of the cutting edges, there will be one blade at the end of each shaft that is closest to the housing. Such blades can be termed the outermost blades.

The outermost blades conventionally have the same shape as all the other blades. This creates a transverse gap or slot between the outermost blade and the housing, which gap gathers material being shredded during use. However, such gathered material has no means of release or escape from the gap, and friction of such moving material against the housing heats the material. Such material is known in the art to be a fire hazard, requiring stoppage of the shredder to clear such material before a fire starts.

The application provides solutions for improving the shredder, resulting in enhanced shredding performance and effectiveness.

### SUMMARY OF THE INVENTION

According to one aspect of the present invention, there is disclosed a shredder for shredding material, the shredder comprising a housing supporting two rotating shafts arranged parallel to each other, each shaft having a plurality of overlapping and offset transverse shredding blades along the shafts able to rotate on the shafts in a complementary fashion to shred the material thereinbetween, the shredding blade on each shaft nearest to the housing being an outermost shredding blade and having a gap between of the outermost shredding blade and the housing, wherein the gap at least partly comprises a V-shape.

The V-shaped gap between the outermost shredding blade and the housing facilitates movement of material out of the gap, avoiding any build up and potential fire hazard, thereby enhancing the shredding process and reducing potential fire risks. The V-shaped gap also reduces the likelihood of material wrapping around the shafts, and assists to dislodge trapped materials as discussed herein, maintaining the efficiency of the shredding process over time.

The shredder provides the use of two rotating shafts with overlapping and offset shredding blades, allowing for efficient shredding of materials. The present invention extends to a shredder having more than two shafts, still having a housing, two shafts and outermost shredding blades as define herein.

Typically, the arrangement of the cutting segments on one shaft is complementary to the arrangement of the cutting segments on the opposing shaft, so as to achieve synchronous and contrary motion of the shafts and the blades, and to achieve a shear action thereinbetween in a manner known in the art. Typically, the opening or clearance between the blades define the grade of shredded material being created. The material grade can be change by replacing the shafts with different blade spacings.

The V-shaped gap defined for the present invention may be formed by any arrangement of the shape of the housing, or a particular wall or side of the housing, and the opposing surface of the outermost shredding blade.

Optionally, the outermost shredding blade is at least partly tapered outwardly and away from the shaft. Optionally, a surface of the outermost shredding blade is substantially or fully tapered outwardly and away from the shaft.

Optionally, the shaft includes a flange, and the flange is at least partly tapered outwardly and away from the shaft. Typically, the flange is set to be transverse from the shaft. Optionally, a surface of the flange is substantially or fully tapered outwardly and away from the shaft.

Optionally, the flange and the outermost shredding blade are either integral or securely fixed to each other. The flange and the outermost shredding blade can be formed together to create a single defined shape, or may be securely fixed to each other using welding or the like, to form a single defined unit.

Optionally, the opposing surfaces of the flange and the outermost shredding blade form the V-shaped gap.

Optionally, the shredder further comprises an end-plate between the outermost shredding blade and the housing. The end plate may be separately formed and added to shredder, optionally retro-fitted to an existing shredder.

Optionally, the end-plate is at least partly tapered outwardly and away from the shaft.

Optionally, the shaft includes an end-plate and a flange, and the end-plate and flange are either integral or securely fixed to each other. The flange and the end-plate can be formed together to create a single defined shape, or may be securely fixed to each other using welding or the like, to form a single defined unit.

Optionally, the shaft includes a flange and end-plate, and the flange, end-plate and outermost shredder blade are either all integral or all securely fixed to each other. The flange, the end-plate and outermost shredder blade can be formed together to create a single defined shape, or may be securely fixed to each other using welding or the like, to form a single defined unit.

Making the parts of the shredder integral with or secured to the shaft ensures a robust connection that can withstand the high torque and stresses involved in the shredding process, leading to increased durability and reliability of the shredder. The secure attachment or welding of such parts to the shaft can also reduce vibrations and noise during operation, providing a more stable and quieter working environment.

The V-shaped gap may have any suitable shape able to encourage any material being shredded, and located in the gap between the housing and the outermost shredder blade, to move away from the shaft as the shaft rotates.

Optionally, the V-shaped gap at least partly comprises a truncated V-shape. In this way, the ‘arms’ of a V-shape do not narrow to a defined point, but have a transverse connecting portion.

Optionally, one or both sides of the V-shaped gap are at least partly curved. In this way, the ‘arms’ of the V-shape do not have to be straight. For example, one or both arms of the V-shape are arcuate, being either convex or concave or a combination of same. Optionally, one or both sides of the V-shaped gap are curved outwardly away from the shaft.

Each shaft may comprise any number of shredding blades, including between 2-10 shredding blades. The range of shredding blades per shaft ensures a balance between throughput and mechanical complexity, optimizing the shredder for various operational scales without overcomplicating the design. For example, a shaft may have 5, 6, 7 or 8 shredding blades. This range also allows for customization based on the type of material to be shredded, providing flexibility in adapting the shredder for different industrial applications, from light to heavy-duty shredding tasks.

Optionally, the outermost shredding blade has a plurality of circumferential cutting members.

Optionally, one or more of the shredding blades has 2 or more cutting members thereon. Having 2 or more cutting members on one or more of the shredding blades allows for a modular design that can be tailored to the specific configuration. For example, a shredding blade may have 3 or 4 cutting members. The cutting members can be arranged around the circumference of the shredding blade, typically in a symmetrical fashion.

This configuration can improve the longevity of the blades by distributing wear more evenly across multiple cutting segments, thereby extending the maintenance intervals and reducing operational costs.

Optionally, at least one of the cutting members in the outermost shredding blade comprises a circumferentially flat surface portion and a circumferentially tapered surface portion.

Optionally, all of the cutting segments in each outermost shredding blade comprises a circumferentially flat portion and a circumferentially tapered portion. In this way, the shredding blade is symmetrical in certain orientations. Ensuring that all cutting members in each outermost shredding blade have both flat and tapered portions standardizes the cutting action across the entire width of the outermost shredding blade. Uniformity in blade design also simplifies manufacturing and potentially reduces costs, as the same machining processes can be applied to all members, while still providing the benefits of a mixed cutting geometry.

Optionally, the shredding blades are rotary hook blades, optionally having 2 or more hooks around their circumference.

Optionally, the shredding blades have a plurality of circumferential cutting members and a series of interspersed spacing. The spacing allows enhances can serve to allow the movement of any trapped material lodged between the outermost blades and the housing to be dislodged, thereby minimizing downtime for maintenance and cleaning.

Optionally, the housing comprises side members and end members, and the shafts are supported at each end by the end members. Optionally, the end members are parallel, and the side members may be partly, substantially or wholly tapered, to create a funnel-like input of material towards the shafts.

Optionally, the housing forms an enclosure for material being shredded, optionally designed to deliberately move material towards the gap between the shafts, and shredded material downwardly from the shredder in a predetermined direction, generally based on using gravity or/and pull-in by the rotary hook blades.

A simple configuration of side members and end members in the housing also facilitates easier assembly and maintenance, as components are accessible and can be individually replaced or serviced.

By supporting the shafts at both ends, the shredder can handle higher loads and more rigorous shredding tasks without compromising the alignment or performance of the shredding mechanism.

Optionally, the housing comprises an inlet above the shafts for material to be shredded, and an outlet below the shafts being smaller than the inlet, for shredded material to be collected or conveyed to another location

Optionally, the housing includes wear plates, typically on end members. Wear plates are considered to be integral with the housing.

Optionally, the shredder is mobile, for example on wheels or tracks.

Optionally, the shredder includes one or more conveyors to convey shredded material to another location, and a hopper for feed material to reach the housing.

The positioning of the inlet above the shafts allows for gravity-assisted feeding of material into the shredder, reducing the need for additional mechanical feeding systems and simplifying the shredding process.

The design of an outlet that is smaller than the inlet ensures that materials are adequately shredded before exiting the machine, leading to consistent shred size and preventing the escape of partially shredded materials. Optionally, the outlet includes one or more sieves or screen for further grading of material provided from the shredder.

Optionally, the shredding blade on each shaft nearest to the housing is an outermost shredding blade, and the shredding blade at the other end of each shaft is an innermost shredding blade, wherein each shaft includes a transverse flange at each end between the shredding blades and the housing, and wherein the diameter of the flange between the outermost shredding blade and the housing is greater than the diameter of the flange between the innermost shredding blade and the housing.

A larger flange between the outermost shredding blade and the housing further discourages trapping of material being shredded between the outermost shredding blade and the housing.

Such an arrangement also means the adjacent flanges of the shredding blades at each end of the housing differ in size. That is, the flange next to the outermost shredding blade can be larger than the adjacent flange next to the innermost shredding blade.

According to another aspect of the present invention, there is provided a shredder for shredding material, the shredder comprising a housing supporting two rotating shafts arranged parallel to each other, each shaft having a plurality of overlapping and offset transverse shredding blades along the shafts able to rotate on the shafts in a complementary fashion to shred the material thereinbetween, the shredding blade on each shaft nearest to the housing being an outermost shredding blade and the shredding blade at the other end of each shaft being an innermost shredding blade, wherein each shaft includes a transverse flange at each end between the shredding blades and the housing, and wherein the diameter of the flange between the outermost shredding blade and the housing is greater than the diameter of the flange between the innermost shredding blade and the housing.

According to another aspect of the present invention, there is provided a method of preventing material accumulation in a shredder, the shredder being as defined herein, comprising at least the step of providing material to the shredder and operating the shredder.

Optionally, the shredder is provided with outermost shredding blade and a flange on the shaft, and the method further comprises the step of merging, optionally by welding, the outermost shredding blade and the flange so as to form a V-shaped gap between of the outermost shredding blade and the housing.

Optionally, the shredder is provided with outermost shredding blade, an end-plate and a flange on the shaft, and the method further comprises the step of merging, optionally by welding, the outermost shredding blade, the end-plate and the flange so as to form a V-shaped gap between of the outermost shredding blade and the housing.

Merging a flange and the outermost shredding blade creates a single defined shape, or a single defined unit, ensures a robust connection that can withstand the high torque and stresses involved in the shredding process, leading to increased durability and reliability of the shredder.

Optionally, the merging of the opposing surfaces of the flange and the outermost shredding blade form the V-shaped gap.

Merging a flange and an end-plate can be formed together to create a single defined shape or single defined unit, ensures a robust connection that can withstand the high torque and stresses involved in the shredding process, leading to increased durability and reliability of the shredder.

Merging a shaft, a flange, an end-plate, and an outermost shredder blade together to create or a single defined unit, ensures a robust connection that can withstand the high torque and stresses involved in the shredding process, leading to increased durability and reliability of the shredder.

The V-shape formed between the end-plate and the cutting segments of the outermost shredding blade creates a non-rectilinear zone for material between the outermost blade and the housing, to contribute to cleaning or self-cleaning of the outermost blades, as the design may help to dislodge trapped materials, reducing downtime for maintenance and cleaning.

In another arrangement, there is disclosed a shredder for shredding material, the shredder comprising one rotating shaft having a plurality of transverse shredding blades along the shaft, the shedding blades having a plurality of circumferential cutting segments, the shredding blades being able to rotate on the shaft to shred the material, a housing supporting the shaft, the shaft having at one or both ends an outermost shredding blade nearest to the housing, and a end-plate between each outermost shredding blade and the housing, characterised in that either the end-plate is tapered towards the outermost shredding blade, or one or more of the cutting segments of the outermost shredding blade are tapered towards the end-plate, or both the end-plate and the one or more of the cutting segments of the outermost shredding blade are tapered towards each other.

### BRIEF DESCRIPTION OF DRAWINGS

The accompanying drawings, which are incorporated in and constitute a part of the specification, illustrate embodiments of the disclosure and together with the detailed description herein, serve to explain the principles of the disclosure. It is emphasized that, in accordance with the standard practice in the industry, various features are not drawn to scale. In fact, the dimensions of the various features may be arbitrarily increased or reduced for clarity of discussion. The drawings are only for purposes of illustrating preferred embodiments and are not to be construed as limiting the disclosure.

FIG. 1a is a perspective view of a prior art cutting blade, in accordance with an aspect of the present disclosure;

FIG. 1b is a side cross-sectional view of the prior art cutting blade of FIG. 1a at the end of a shaft and next to housing of a prior art shedder, in accordance with an aspect of the present disclosure;

FIG. 1c is a perspective view of FIG. 1b, with trapped material, in accordance with an aspect of the present disclosure;

FIG. 2 is a perspective view of a shredder according to an embodiment of the present invention, in accordance with an aspect of the present disclosure;

FIG. 2a is a perspective view of a shredding blade for use in the shredder of FIG. 2, in accordance with an aspect of the present disclosure;

FIG. 3a is a side cross-sectional view of the shredding blade of FIG. 2a at the end of a shaft and next to an end-plate and housing of a shedder according to one embodiment of present invention, in accordance with an aspect of the present disclosure;

FIG. 3b side cross-sectional view of FIG. 3 after merging of the flange and end-plate, in accordance with an aspect of the present disclosure;

FIGS. 4-1 to 4-12 are side cross-sectional views of a shredding blade and housing variants for use in a shedder according to further embodiments of present invention, in accordance with an aspect of the present disclosure;

FIGS. 4a to 4d are side cross-sectional views of FIG. 4-5, FIG. 4-6, FIG. 4-3 and FIG. 4-10 respectively after merging of the flange, any end-plate and the outermost shredder blade, in accordance with an aspect of the present disclosure;

FIG. 5 is a perspective view of the shredding blade at the end of a shaft and next to an end-plate and housing of a shedder shown in FIG. 3, in accordance with an aspect of the present disclosure;

FIGS. 6 and 7 are vertical and perspective views of two shafts and shredding blades and end plates (but without housing) for use in a shredder according to another embodiment of the present invention, in accordance with an aspect of the present disclosure; and

FIG. 8 is an end view of another embodiment, in accordance with an aspect of the present disclosure.

### DETAILED DESCRIPTION FOR CARRYING OUT THE INVENTION

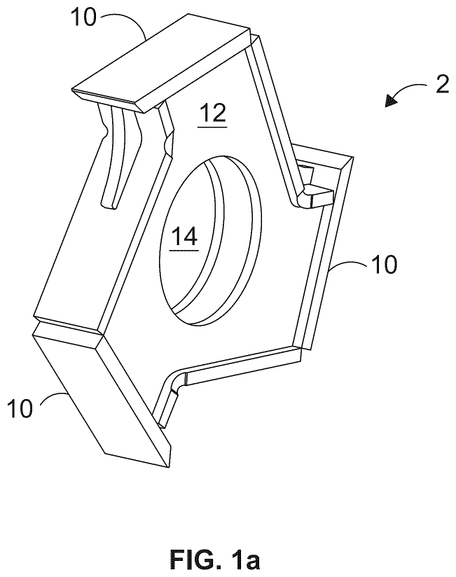

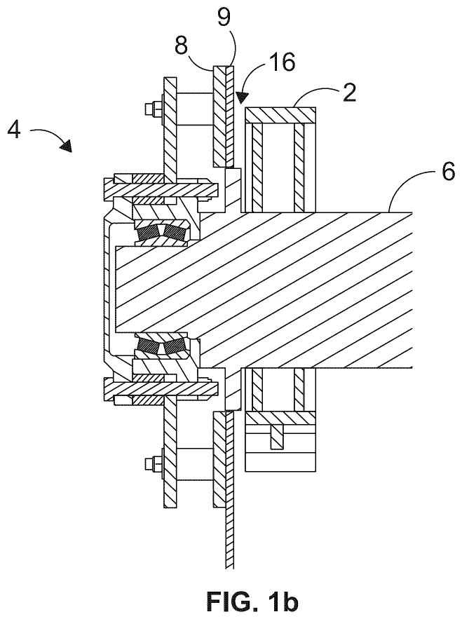

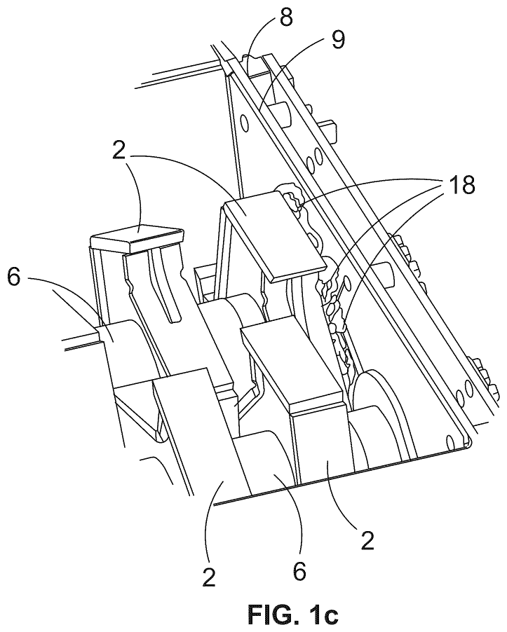

FIGS. 1a and 1b show a prior art cutting blade 2 for an industrial shredder 4. Industrial shredders are known in the art, generally having two parallel shafts 6 (one shown in FIG. 1b, two shown in FIG. 1c), with overlapping cutting blades 2 thereon within a housing 8. The cutting blades 2 are designed to rotate in contrary motion so as to produce a shear force thereinbetween, which force can shred or reduce or crush etc. the material fed into the shedder. FIG. 1c shows a number of overlapping cutting blades 2 on two shafts 6 contra-rotating within a housing 8. The end of the housing has an integral wear plate 9 bolted thereto.

The prior art cutting blades 2 have a series of transverse cutting hooks or surfaces 10 around the circumference of a thick circular body 12 extending out from their centre 14, which is welded to the shaft 6. The prior art cutting blades 2 can be 3-hook rotary hook blades known in the art. The blades 2 alternate along the shaft 6 as shown in FIG. 1c, to produce a complementary and overlapping arrangement of the cutting edges 10.

Conventionally, all the cutting blades 2 on each shaft 6 are the same. This creates a transverse slot 16 between the blade 2 nearest to the housing 8, which slot 16 gathers and traps material 18 shown in FIG. 1c being shredded during use. However, such gathered material 18 has no means of release or escape from the slot 16, and so there is friction between such moving material 18 against the housing 8, which naturally heats the material 18. Such material is known in the art to be a fire hazard, requiring stoppage of the shredder to clear such material before a fire starts.

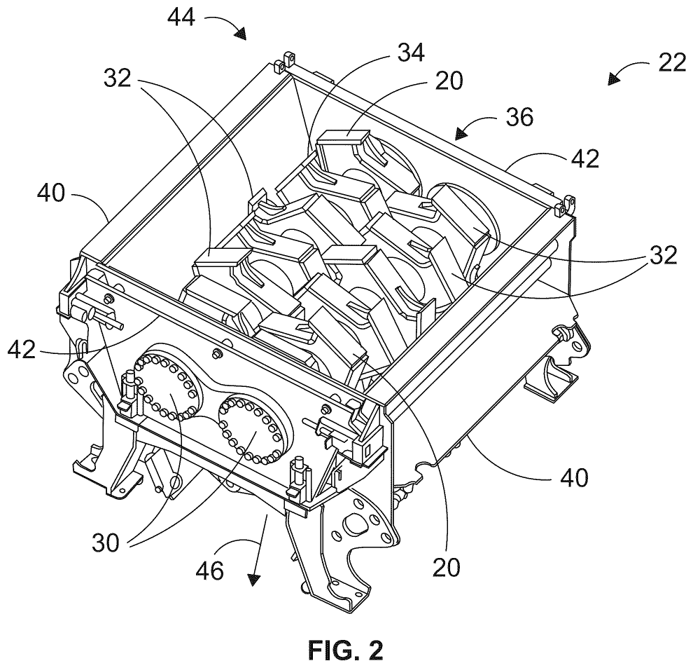

FIG. 2 shows the shredder 22 for shredding material, the shredder 22 comprising two rotating shafts 30 arranged parallel to each other, each shaft 30 having a plurality of overlapping and offset transverse shredding blades 32 along the shafts 30, the shedding blades 32 having a plurality of circumferential cutting members 34, the shredding blades 32 being able to rotate on the shafts 30 in a complementary fashion to shred the material thereinbetween.

FIG. 2 also shows a housing 36 comprising two side members 40 and two end members 42, wherein the shafts 30 are supported at each end by the end members 42 in a manner known in the art. A motor or motors to drive the shafts 30 are not shown. The skilled reader can understand that the motor(s) provide synchronous, asynchronous, and contrary motion of the shafts 30 and the blades 20, to achieve a shear action thereinbetween in a manner known in the art.

FIG. 2 also shows the housing 36 comprising an inlet 44 above the shafts 30 for the provision of material to be shredded, and an outlet 46 below the shafts 30 being smaller than the inlet. The housing 36 forms an enclosure for material being supplied to the inlet 44 to be shredded between the shafts 30, with shredded material going downwardly from the shredder 22 to the outlet 46, generally based on using gravity. A conveyor (not shown) can convey the shredded material to another location. The shredder 22 can be on a mobile platform, such as a tracked chassis, for use around different sites or parts of a site when required. Thus, FIG. 2 shows a method of using a shredder in accordance with another embodiment of the present invention.

FIG. 2 also shows each shaft 30 having an outermost shredding blade 20 of the shredding blades 32 nearest to the housing 36.

FIG. 2a shows an example of an outermost shredder blade 20 for use in a shredder 22 according to one embodiment of the present invention, such as the example shown in FIG. 2. The outermost shredding blade 20 comprises three cutting members 24. Each cutting member 24 is designed to have a circumferentially flat surface 26 and a circumferentially tapered surface 28. The flat surface 24 and the tapered surface 26 are welded onto a suitable support on the outermost shredding blade 20.

FIG. 2 also shows an end-plate 38 fixed, such as welded, to the outermost shredding blade 20.

Between the cutting members 24 of the outermost shredding blade 20 shown in FIG. 2a are three intermediate spaces 25, having a smaller radial distance from the shaft to be located within the centre 29 of the outermost shredding blade 20, than the radial distance of the cutting members 24 from the same shaft.

FIGS. 6 and 7 only show the shafts 30 and the series of overlapping and offset transverse shredding blades 32 more clearly set along the shafts 30, including outermost shredding blades 20, and the end-plates 38. Each shaft 30 has 6 shredding blades 32, 20 thereon. Each shredding blade 32, 20 has three cutting members thereon. The cutting members 24a on the shredding blades 32 not being the outermost shredding blades 20, may be of a shape and position known in the art, such as a 3-hook rotary hook blade. FIGS. 6 and 7 show the cutting segments 24, 24a of each shredding blade 32, 20 having a regular but offset positioning longitudinally along the shaft 30, in a manner known in the art.

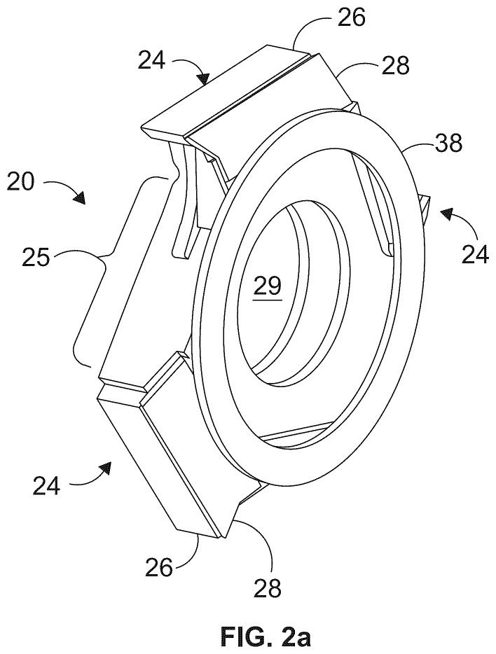

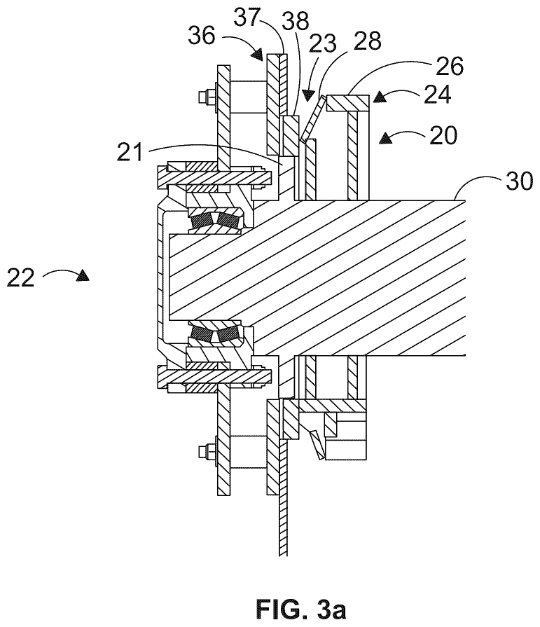

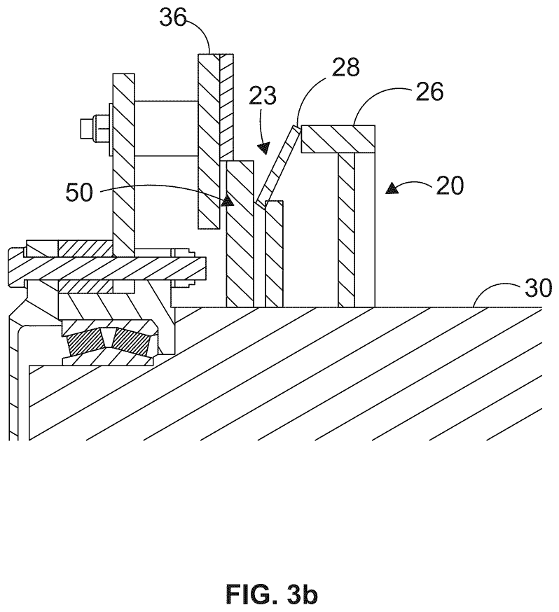

FIG. 3a shows a cross-section of an end portion of one embodiment of the shredder 22, having the housing 36 supporting a shaft 30, the shaft 30 supporting the outermost shredding blade 20 shown in FIG. 2a, with the end-plate 38 between the outermost shredding blade 20 and the housing 36. FIG. 3a shows the circumferentially flat surface 26 and a circumferentially tapered surface 28 of the cutting member 24 of the outermost shredding blade 20. The circumferentially tapered portion 28 tapers towards the end-plate 38, or outwardly away from the shaft 30. The housing 36 has a wear plate 37. The shaft has a flange 21.

FIG. 3a shows a gap 23 between of the outermost shredding blade 20 and the housing 36, wherein the gap 23 at least partly comprises a V-shape. The V-shape is created by the opposing surfaces of the end-plate 38 and the tapered surface 28 of the cutting member 24.

In FIG. 3a, the end plate 38 is integral to the outermost shredding blade 20, either by welding or being forged therewith.

FIG. 3b shows a similar but alternative arrangement to that shown in FIG. 3a, wherein the flange 21 and end-plate 38 of FIG. 3a have been merged or welded into a single plate 50. The single plate 50 is welded to the shaft 30. Optionally, the single plate 50 is also welded to the outermost shredding blade 20.

FIGS. 4-1 to 4-12 show cross-sections of a portion of a number of other embodiments of a shredder according to the present invention. To assist clarity, each of FIGS. 4-1 to 4-12 show a general housing 66 supporting a general shaft 60, the shaft 60 supporting a variation of a shredder blade, flange and end plate as follows;

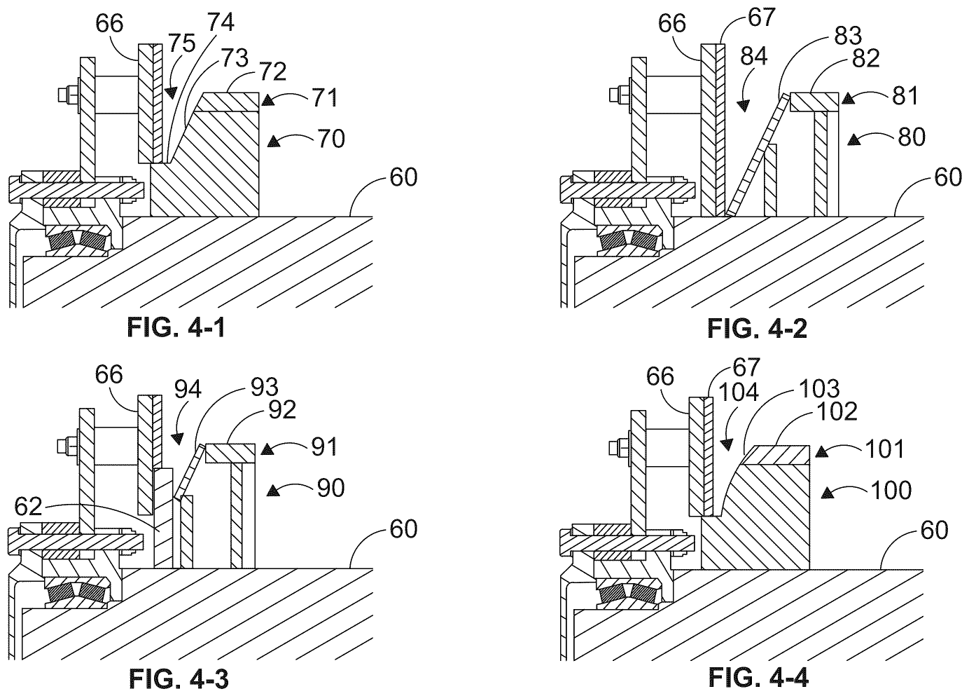

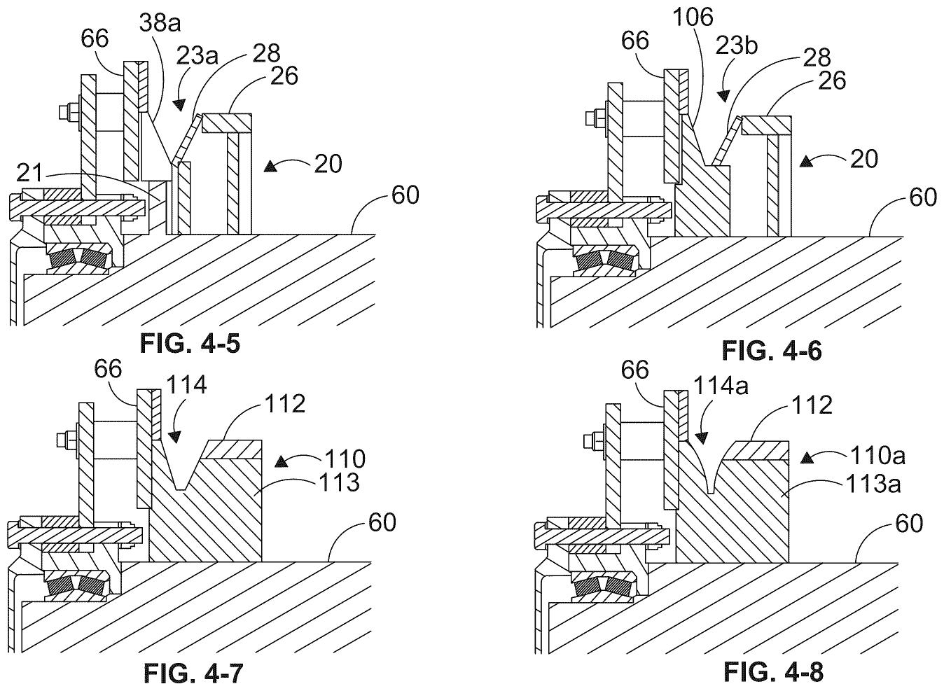

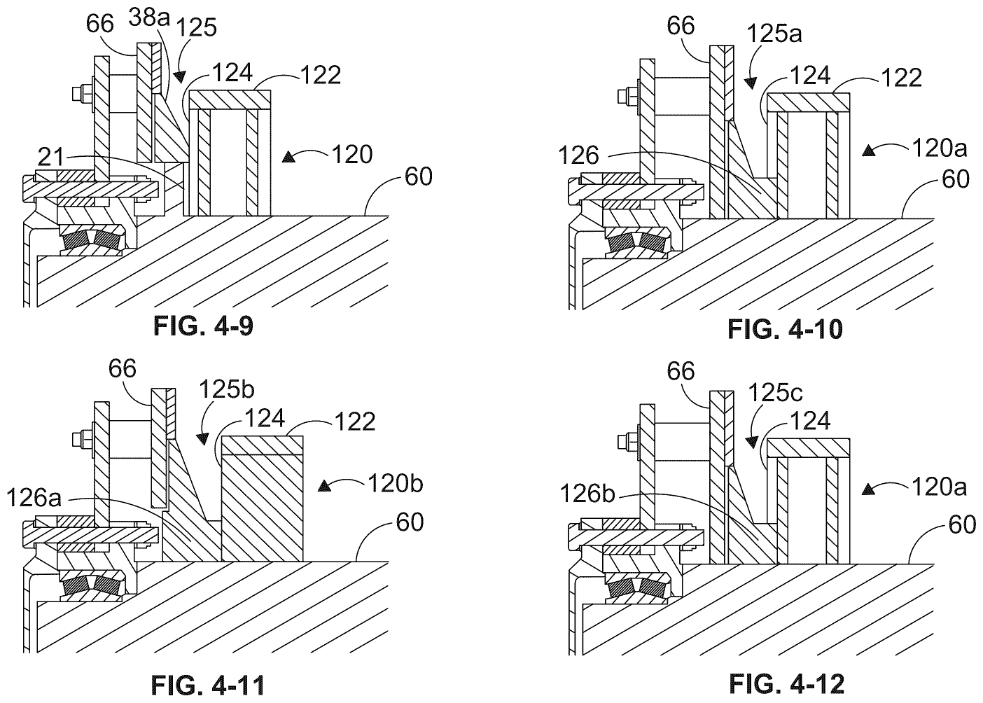

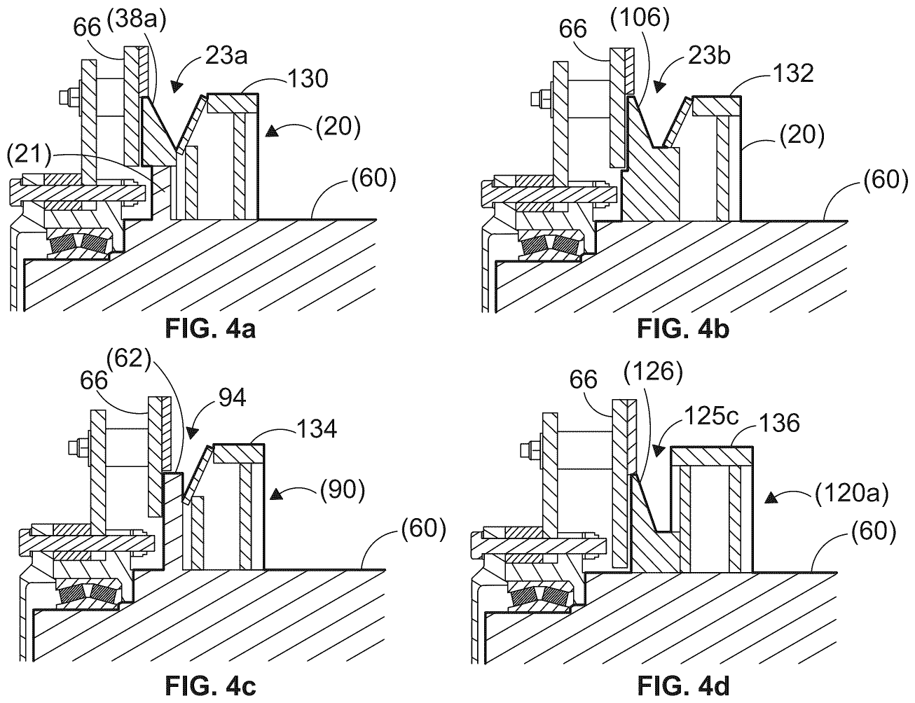

FIG. 4-1 shows an outermost shredder blade 70 having a cutting member 71 having a circumferentially flat surface 72 and a circumferentially tapered surface 73 tapering outwardly away from the shaft 60. The outermost shredder blade 70 has a flat surface 74 next to the housing 66, such that the gap 75 is a truncated V-shape.

The outermost shredder blade 70 is a solid or unified unit.

FIG. 4-2 shows an outermost shredder blade 80 having a cutting member 81 having a circumferentially flat surface 82 and a circumferentially tapered surface 83 extending down to the shaft 60, and tapering outwardly away from the shaft 60. FIG. 4-2 shows the wear-plate 67 also extending to the shaft 60, to create the V-shaped gap 84 thereinbetween. FIG. 4-2 only requires the addition of the extended circumferentially tapered surface 83 to a conventional shredder blade.

FIG. 4-3 shows an outermost shredder blade 90 having a cutting member 91 having a circumferentially flat surface 92 and a circumferentially tapered surface 93 tapering outwardly away from the shaft 60. The outermost shredder blade 90 can be the same as the outermost shredder blade 20 show in FIG. 2a, with the end-plate 38.

FIG. 4-3 shows the shaft 60 having a wider or extended flange 62, to create a V-shaped gap 94 between the extended flange 62 and the circumferentially tapered surface 93.

FIG. 4-4 is a variant of the embodiment shown in FIG. 4-1, showing an outermost shredder blade 100 having a cutting member 101 having a circumferentially flat surface 102 and an arcuate circumferentially tapered surface 103 tapering outwardly away from the shaft 60. The arcuate circumferentially tapered surface 103 and housing 66 and wear-plate 67 form a curved V-shaped gap 104, curving outwardly away from the shaft 60.

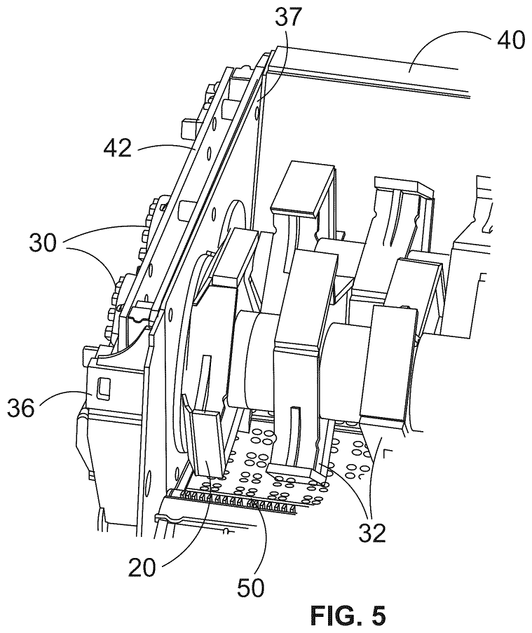

FIG. 4-5 is a variant of the embodiment shown in FIG. 3, showing an outermost shredder blade 20 having a cutting member having a flat surface 26 and a tapered surface 28 tapering outwardly away from the shaft 60. The variation is a tapered end-plate 38a forming a V-shaped gap 23a extending outwardly away from the shaft 60 between the end-plate 38a and the tapered surface 28.

FIG. 4-6 is a variant of the embodiment shown in FIG. 4-5, showing an outermost shredder blade 20 having a cutting member having a flat surface 26 and a tapered surface 28 tapering outwardly away from the shaft 60. The variation is a combination or merging of the flange 21 and tapered end-plate 38a shown in FIG. 4-5 into a single unit 106 forming a truncated V-shaped gap 23b extending outwardly away from the shaft 60 between single unit 106 and the tapered surface 28.

FIG. 4-7 is a variant of the embodiment shown in FIG. 4-6, showing an outermost shredder blade 110 having a cutting member having a flat surface 112, and a tapered surface formed by a combination or merging of the flange/end-plate/body of the outermost shredder blade 110 into a single unit 113, which has a truncated V-shaped gap 114 extending outwardly away from the shaft 60.

FIG. 4-8 is a variant of the embodiment shown in FIG. 4-8, showing an outermost shredder blade 110a having a cutting member having a flat surface 112, and a tapered surface formed by a combination or merging of the flange/end-plate/body of the outermost shredder blade 110 into a single unit 113a, which has a truncated and arcuate V-shaped gap 114a extending outwardly away from the shaft 60. Both arms of the gap 114a made in the single unit 113a are accurate.

FIG. 4-9 is a variant of the embodiment shown in FIG. 4-5, showing an outermost shredder blade 120 having a cutting member having a flat surface 122 and orthogonal sides 124. As such the outermost shredder blade 120 may be similar to a known shredder blade. The variation is a tapered end-plate 38a forming a V-shaped gap 125 extending outwardly away from the shaft 60 between the end-plate 38a and the straight side 124 of the outermost shredder blade 120.

FIG. 4-10 is a variant of the embodiment shown in FIG. 4-9, showing a similar outermost shredder blade 120a having a cutting member having a flat surface 122 and orthogonal sides 124. The variation is a combination or merging of the flange 21 and tapered end-plate 38a shown in FIG. 4-9 into a single unit 126 forming a truncated V-shaped gap 125a extending outwardly away from the shaft 60 between single unit 126 and the straight side 124 of the outermost shredder blade 120a.

FIG. 4-11 is a variant of the embodiment shown in FIG. 4-10, showing a similar outermost shredder blade 120b being a solid unit, and having a cutting member having a flat surface 122 and orthogonal sides 124. The variation is the single unit 126a extending further from the shaft 60 to form a different truncated V-shaped gap 125b extending outwardly away from the shaft 60 between single unit 126a and the straight side 124 of the outermost shredder blade 120a.

FIG. 4-12 is a variant of the embodiment shown in FIG. 4-10, showing the outermost shredder blade 120a having a cutting member having a flat surface 122 and orthogonal sides 124. The variation a single unit 126b forming a truncated and arcuate V-shaped gap 125b extending outwardly away from the shaft 60 between single unit 126b and the straight side 124 of the outermost shredder blade 120a.

FIGS. 4-1 to 4-12 show various arrangements for an end-plate and/or a flange and/or the one or more of the cutting segments of the outermost shredding blade, to form various V-shaped gaps thereinbetween. The tapering creates a V-shaped clearance at the edges, which reduces the likelihood of material being trapped, and possibly wrapping around the shafts. The V-shaped gap formed between the end-plate and the cutting segments of the outermost shredding blade creates a non-rectilinear zone for material between the outermost blade and the housing. This contributes to cleaning or self-cleaning of the outermost blades, and helps dislodge trapped materials, reducing downtime for maintenance and cleaning.

FIG. 4a shows another view of the embodiment of FIG. 4-5, wherein the shaft 60a, the outermost shredder blade 20, the tapered end-plate 38a and the flange 21 form a single unit 130, which in itself provides the V-shaped gap 23a extending outwardly away from the shaft 60. The single unit 130 may be formed, forged or welded together.

FIG. 4b shows another view of the embodiment of FIG. 4-6, wherein the shaft 60, the outermost shredder blade 20 and the single unit 106 form a further single unit 132, which in itself provides the V-shaped gap 23b extending outwardly away from the shaft 60. The single unit 132 may be formed, forged or welded together.

FIG. 4c shows another view of the embodiment of FIG. 4-3, wherein the shaft 60, the outermost shredder blade 90, the flange 62 form a single unit 134, which in itself provides the V-shaped gap 94 extending outwardly away from the shaft 60. The single unit 134 may be formed, forged or welded together. The single unit 134 forms a robust structure, having a V-shaped gap 94 with smaller side-walls than other embodiments and arrangements, leaving less room for any material to be trapped therein during use.

FIG. 4d shows another view of the embodiment of FIG. 4-10, wherein the shaft 60, the outermost shredder blade 120a, and the single unit 126 form a further single unit 136, which in itself provides the V-shaped gap 125c extending outwardly away from the shaft 60. The single unit 136 may be formed, forged or welded together.

FIGS. 4a-4d shows embodiments for methods of using the present invention comprising the step of merging, optionally by welding, an outermost shredding blade and a flange so as to form a V-shaped gap between of the outermost shredding blade and the housing, and optionally comprising the step of merging, optionally by welding, an outermost shredding blade, an end-plate and a flange so as to form a V-shaped gap between of the outermost shredding blade and the housing.

FIG. 5 shows a cross-section of a portion of another embodiment of the shredder 22 of FIG. 2, having the housing 36 supporting a shaft 30, the shaft 30 supporting the outermost shredding blade 20 shown in FIG. 2, and the second end-plate 38a between the outermost shredding blade 20 and the housing 36. FIG. 5 shows both the cutting segments 24 of the outermost shredding blade 20 being tapered towards the end-plate 38, and the second end plate 38a being tapered towards the shredding blade 20. FIG. 5 also shows the shredder 30 having a screen 50 below the shafts 30 to further grade material being shredded by the shredder before the outlet 46.

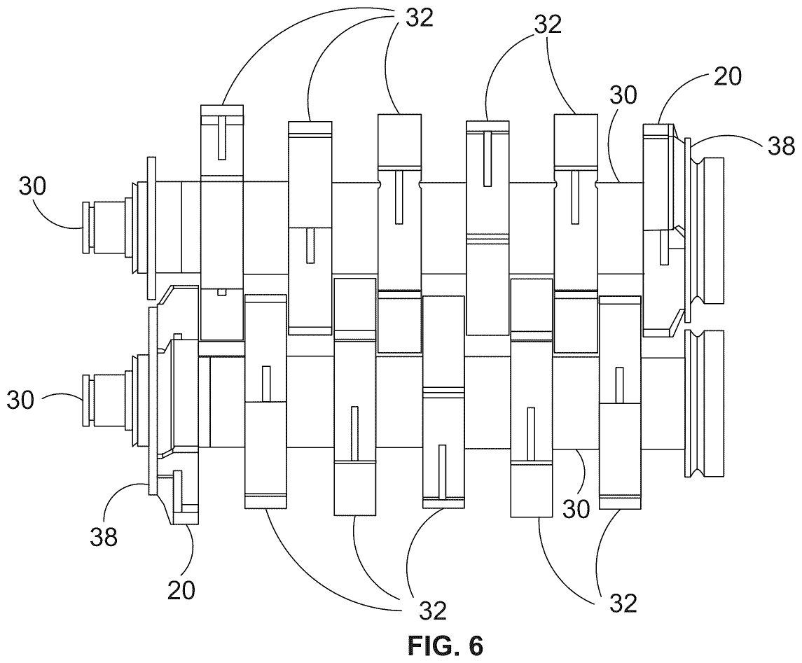

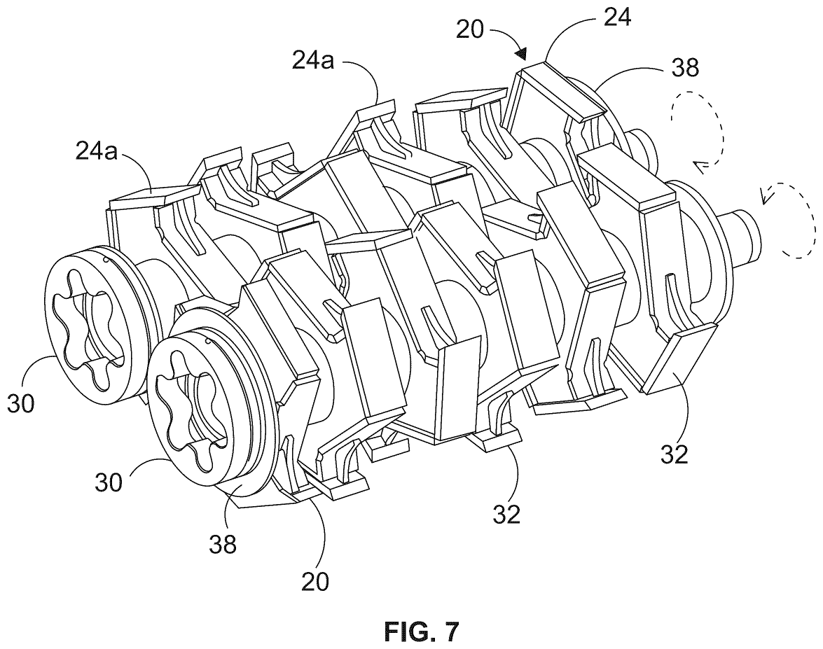

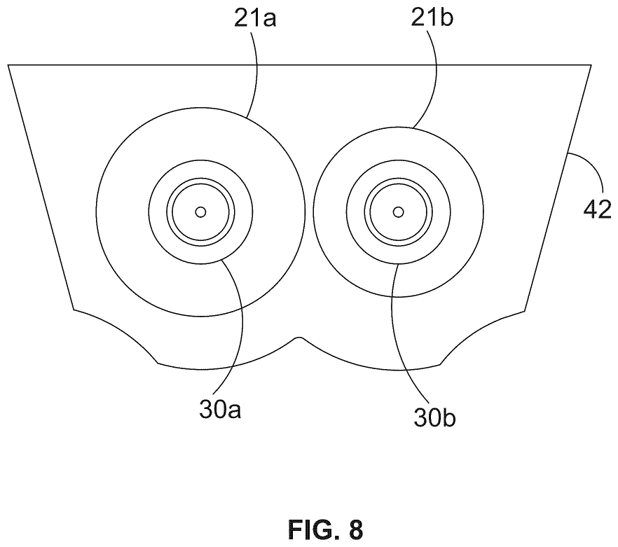

FIG. 8 shows an end view of FIG. 6, being the two rotating shafts 30 arranged parallel to each other, support by the end member 42 of a housing. FIG. 8 shows one shaft 30a having a first transverse flange 21a, and a second shaft 30b having a second transverse flange 21b, wherein the diameter of the first flange 21a between an outermost shredding blade (not shown in FIG. 8) and the end member 42 of a housing is greater than the diameter of the second flange 21b between the innermost shredding blade and end member 42 of a housing. In this way, the larger flange 21a between the outermost shredding blade and the housing further discourages trapping of material being shredded between the outermost shredding blade and the housing. In this way, the adjacent flanges 21a, 21b of the shredding blades at each end of the housing differ in size. That is, the flange next to the outermost shredding blade can be larger than the adjacent flange next to the innermost shredding blade. The arrangement shown in FIG. 8 is also shown in FIGS. 2, 6 and 7.

The present invention provides a method of preventing material accumulation and the associated friction in a shredder, so that the risk of fire hazards is significantly diminished. The present invention ensures that the blades operate smoothly without generating excessive heat. The V-shape design of the present invention also improves the overall operational stability of the shredder, leading to more consistent performance and reducing the likelihood of shutdowns or failures caused by clogged material. The tapered blade design leads to smoother and more efficient shredding, enhancing throughput and reducing downtime caused by jams or blockages.

By angling the contact area between the shredder blade tips and the end-plate, any trapped material is significantly reduced, minimizing friction. This lowers the risk of heat buildup and potential fire hazards that could result from constant frictional contact. Furthermore, the tapered design promotes better material flow through the shredder, allowing debris to move past the blades more easily without getting stuck.

The reduced friction and material buildup also contribute to less wear and tear on both the outermost blades and the end plates. This results in extended lifespan for these critical components, reducing the frequency of maintenance and replacement.

The tapered blades help in evenly distributing the shredding load, preventing stress concentration on the end areas, which can lead to premature wear.

The present invention also helps maintain consistent output particle size by ensuring material is continuously processed without interruption. The reduced wear on blades and end plates translates into lower maintenance costs, as parts require less frequent servicing or replacement. With fewer instances of material buildup, maintenance tasks become quicker and less frequent, further reducing operational costs. By minimizing fire risks and ensuring stable operation, the design enhances overall workplace safety, protecting both the equipment and personnel.

As may be recognized by those of ordinary skill in the art based on the teachings herein, numerous changes and modifications may be made to the above-described and other embodiments of the present disclosure without departing from the scope of the disclosure. The components of the invention as disclosed in the specification, including the accompanying abstract and drawings, may be replaced by alternative component(s) or feature(s), such as those disclosed in another embodiment, which serve the same, equivalent or similar purpose as known by those skilled in the art to achieve the same, equivalent or similar results by such alternative component(s) or feature(s) to provide a similar function for the intended purpose. In addition, the invention may include more or fewer components or features than the embodiments as described and illustrated herein. Accordingly, this detailed description of the currently-preferred embodiment is to be taken in an illustrative, as opposed to limiting of the disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or invention that “comprises,” “has,” “includes,” or “contains” one or more steps or elements possesses those one or more steps or elements, but is not limited to possessing only those one or more steps or elements. Likewise, a step of a method or an element of the invention that “comprises,” “has,” “includes,” or “contains” one or more features possesses those one or more features, but is not limited to possessing only those one or more features. Furthermore, an invention or structure that is configured in a certain way is configured in at least that way, but may also be configured in ways that are not listed.

The disclosure has been described with reference to the preferred embodiments. It will be understood that the architectural and operational embodiments described herein are exemplary of a plurality of possible arrangements to provide the same general features, characteristics, and general system operation. Modifications and alterations will occur to others upon a reading and understanding of the preceding detailed description. It is intended that the disclosure be construed as including all such modifications and alterations.

1. A shredder for shredding material, the shredder comprising a housing supporting two rotating shafts arranged parallel to each other, each shaft having a plurality of overlapping and offset transverse shredding blades along the shafts able to rotate on the shafts in a complementary fashion to shred the material thereinbetween, the shredding blade on each shaft nearest to the housing being an outermost shredding blade and having a gap between of the outermost shredding blade and the housing, wherein the gap at least partly comprises a V-shape.

2. A shredder as claimed in claim 1, wherein the outermost shredding blade is at least partly tapered outwardly and away from the shaft.

3. A shredder as claimed in claim 1, wherein the shaft includes a flange, and the flange is at least partly tapered outwardly and away from the shaft.

4. A shredder as claimed in claim 3, wherein the flange and the outermost shredding blade are either integral or securely fixed to each other.

5. A shredder as claimed in claim 1, further comprising an end-plate between the outermost shredding blade and the housing.

6. A shredder as claimed in claim 4, wherein the end-plate is at least partly tapered outwardly and away from the shaft.

7. A shredder as claimed in claim 5, wherein the shaft includes a flange, and the end-plate and flange are either integral or securely fixed to each other.

8. A shredder as claimed in claim 5, wherein the shaft includes a flange, and the end-plate, flange and outermost shredder blade are either all integral or all securely fixed to each other.

9. A shredder as claimed in claim 1, wherein the V-shaped gap at least partly comprises a truncated V-shape.

10. A shredder as claimed in claim 1, wherein one or both sides of the V-shaped gap are at least partly curved.

11. A shredder as claimed in claim 10, wherein the one or both sides of the V-shaped gap are curved outwardly away from the shaft.

12. A shredder as claimed in claim 1, wherein the outermost shredding blade has a plurality of circumferential cutting members.

13. A shredder as claimed in claim 12, wherein at least one of the cutting members in the outermost shredding blade comprises a circumferentially flat surface portion and a circumferentially tapered surface portion.

14. A shredder as claimed in claim 13, wherein all of the cutting segments in each outermost shredding blade comprises a circumferentially flat portion and a circumferentially tapered portion.

15. A shredder as claimed in claim 1, wherein the shredding blades are rotary hook blades.

16. A shredder as claimed in claim 12, wherein the shredding blades have a plurality of circumferential cutting members and a series of interspersed spacing.

17. A shredder as claimed in claim 1, wherein the housing comprises a side members and end members, and the shafts are supported at each end by the end members.

18. A shredder as claimed in claim 1, wherein the housing comprises an inlet above the shafts for material to be shredded, and an outlet below the shafts being smaller than the inlet.

19. A shredder as claimed in claim 1, wherein the shredding blade on each shaft nearest to the housing is an outermost shredding blade, and the shredding blade at the other end of each shaft is an innermost shredding blade,
wherein each shaft includes a transverse flange at each end between the shredding blades and the housing, and wherein the diameter of the flange between the outermost shredding blade and the housing is greater than the diameter of the flange between the innermost shredding blade and the housing.

20. A shredder for shredding material, the shredder comprising a housing supporting two rotating shafts arranged parallel to each other, each shaft having a plurality of overlapping and offset transverse shredding blades along the shafts able to rotate on the shafts in a complementary fashion to shred the material thereinbetween, the shredding blade on each shaft nearest to the housing being an outermost shredding blade and the shredding blade at the other end of each shaft being an innermost shredding blade
wherein each shaft includes a transverse flange at each end between the shredding blades and the housing, and wherein the diameter of the flange between the outermost shredding blade and the housing is greater than the diameter of the flange between the innermost shredding blade and the housing.

21. (canceled)

22. (canceled)

23. (canceled)
